(19) United States
(12) Patent Application Publication
(10) Pub. No.: US 2017/0055773 A1
(43) Pub. Date: Mar. 2, 2017

(54) Sear Tool

(71) Applicant: Prince Castle LLC, Carol Stream, IL (US)

(72) Inventors: Eugene S. Maslana, Arlington Heights, IL (US); Karl Heinze, West Chicago, IL (US)

(73) Assignee: Prince Castle LLC, Carol Stream, IL (US)

(21) Appl. No.: 15/245,677

(22) Filed: Aug. 24, 2016

Related U.S. Application Data
(63) Continuation-in-part of application No. 29/540,457, filed on Sep. 24, 2015.
(60) Provisional application No. 62/210,742, filed on Aug. 27, 2015.

(51) Int. Cl. A47J 37/10; A47J 37/06

(52) U.S. Cl. CPC A47J 37/108; A47J 37/06

(57) ABSTRACT

A sear tool includes an upper assembly and a lower assembly. The upper assembly includes a plurality of arms. Each arm of the plurality of arms terminates in an extension end. The lower assembly includes a sear plate and a plurality of projections that extend away from the sear plate. The lower assembly is movably engaged with the upper assembly such that the upper assembly and the lower assembly are movable between a compressed position and an extended position. A spring is disposed between the upper assembly and the lower assembly. The spring biases the upper assembly and the lower assembly into the extended position.

### CROSS REFERENCE TO RELATED APPLICATION

The present application claims priority of U.S. Provisional Patent Application No. 62/210,742, filed on Aug. 27, 2015 and is a continuation-in-part of U.S. Design patent application Ser. No. 29/540,457, filed Sep. 24, 2015, the contents of which are hereby incorporated herein by reference in their entireties.

### BACKGROUND

In restaurant and or food preparation service industries, it may be desirable to achieve the cooking technique of a sear which is a burning or charring on the surface of a piece of food. Often, a sear is desirable in the preparation of meat, for example on a hamburger or steak. In a restaurant or food preparation service, it is further desirable to achieve a sear on the food in a fast and uniform manner. For example, this has been previously achieved using a press exemplarily constructed of cast iron to place additional weight on the food against the cooking surface.

However, it has been discovered that these presses offer little in the way of control of the force placed on the food and, if a food worker pushes against the press, this force is translated through the press onto the food which may lead to excessive force being placed on the food. Excessive force placed upon the food may cause overcooking and/or compression of the food. In the case of hamburger, this may press the food thinner than a desired thickness. Excessive compression of the food can also squeeze fluid out of the food during cooking. By removing this liquid from the food, the food can become dry during cooking.

### BRIEF DISCLOSURE

An exemplary embodiment of a sear tool includes an upper assembly with a handle and at least one extension terminating in an end. The sear tool further includes a lower assembly with a sear plate. At least one projection extends from the sear plate. The lower assembly movably engages the upper assembly such that the sear plate is movable to a first position and a second position. In the first position the sear plate is closer to the handle than the end of the at least one extension. In the second position, the sear plate is at least even with the end of the at least one extension from the handle. A spring is disposed between the upper assembly and the lower assembly. The spring biases the sear plate in the second position.

Another exemplary embodiment of a sear tool includes an upper assembly. The upper assembly includes a handle and a plurality of arms. Each arm of the plurality of arms includes an extension that extends away from each arm and terminates in an extension end. Each arm of the plurality of arms includes an aperture. A lower assembly includes a sear plate and a plurality of projections that extend away from the sear plate. A portion of each projection of the plurality of projections extends into an aperture of an arm of the plurality of arms. The lower assembly is movably engaged with the upper assembly such that the upper assembly and the lower assembly are movable between a compressed position and an extended position. A spring is disposed between the upper assembly and the lower assembly. The spring biases the upper assembly and the lower assembly into the extended position.

A method of cooking food includes placing a piece of food on a cook surface. The food is engaged with a sear tool. The sear tool includes an upper assembly including a handle and a plurality of arms. Each arm of the plurality of arms includes an extension that extends away from each arm and terminates in an extension end. A lower assembly includes a sear plate. The lower assembly further includes a plurality of projections that extend away from the sear plate. The lower assembly is movably engaged with the upper assembly such that the upper assembly and the lower assembly are movable between a compressed position and an extended position. A spring is disposed between the upper assembly and the lower assembly. The spring biases the sear plate in the extended position. A force is applied against the handle that overcomes the biasing force of the spring to move the upper assembly towards the cook surface. The extension ends of the upper assembly engage the cook surface. The biasing force of the spring is applied against the food to aid searing.

### BRIEF DESCRIPTION OF THE DRAWINGS

FIG. 1 depicts an exemplary embodiment of a sear tool.

FIG. 2 is an exploded view of the exemplary embodiment of the sear tool depicted in FIG. 1.

FIG. 3 is a perspective view of an additional exemplary embodiment of a sear tool.

FIG. 4 is a front view of the additional exemplary embodiment of the sear tool.

FIG. 5 is a sectional view of the sear tool taken along line 5-5 of FIG. 3.

FIG. 6 is a front view of the sear tool with the lower assembly rotated for disassembly.

### DETAILED DISCLOSURE

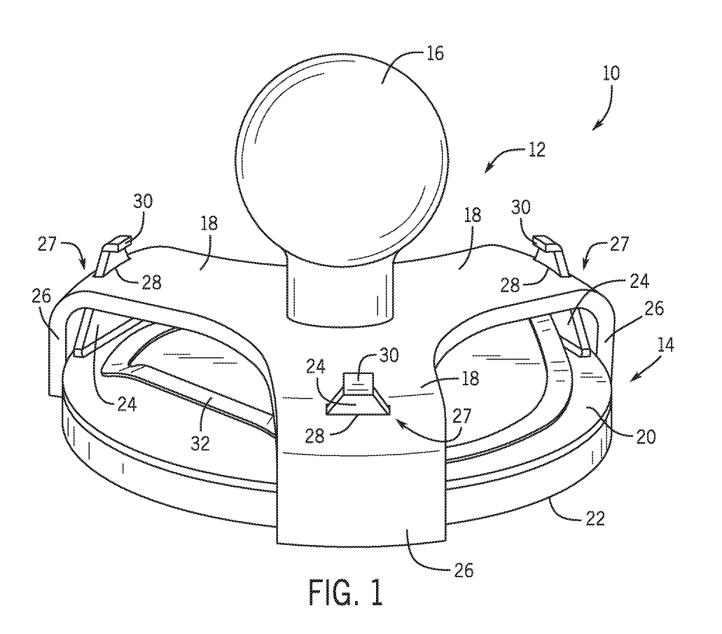

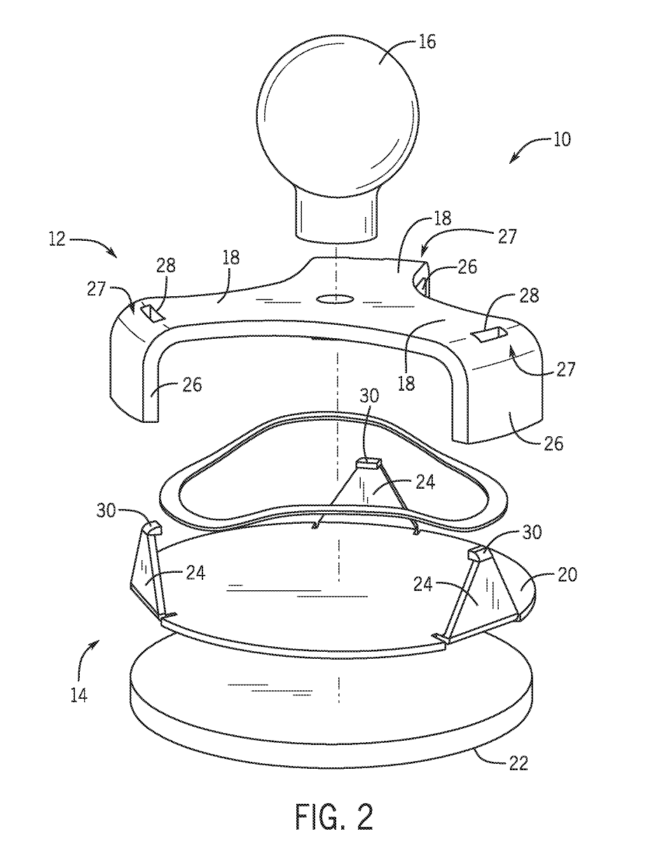

FIGS. 1 and 2 depict an exemplary embodiment of a sear tool 10. FIG. 1 is a perspective view of the sear tool 10 and FIG. 2 is an exploded view of the sear tool 10. The sear tool 10 includes an upper assembly 12 and a lower assembly 14. The upper assembly 12 includes a handle 16. The upper assembly further includes a plurality of arms 18. The handle 16 is exemplarily connected to the plurality of arms 18. As depicted in FIGS. 1 and 2, the handle 16 may exemplarily be connected at the center or a meeting point of the plurality of arms 18. In the exemplary embodiment depicted in FIGS. 1 and 2, the sear tool 10 includes three arms 18. The three arms extend radially outward from the center point. It will be recognized that other numbers of arms 14 may be used in other embodiments, including, but not limited to two arms or four arms. The lower assembly 14 includes a sear plate 20 which is configured to engage a piece of food, exemplarily a burger patty 22. The sear plate 20 is exemplarily round in shape, although it will be recognized that other shapes may be used while remaining within the scope of the present disclosure, particularly other shapes configured to sear pieces of food of other shapes from the traditional circle shape of a burger patty. In non-limiting embodiments, the sear plate 20 may be square shaped, rectangularly shaped or may be elliptical in shape. An elliptical or rectangular shape may be exemplarily used in embodiments configured for use with other foods, for example, but not limited to chicken breast or vegetables, although this merely exemplary and not intended to be limiting. Additionally, the sear plate 20 may be flat or embossed with any of a variety of designs, including, but not limited to images or “grill” lines.

A plurality of projections 24 extend upwards from the sear plate 20. The projections 24 extend generally in the direction away from the side of the sear plate 20 configured to engage the burger patty 22. In the embodiment depicted in FIGS. 1 and 2, the projections 24 are exemplarily triangular in shape and exemplarily so configured to operate in a manner as described in further detail herein.

The arms 18 include extensions 26 which extend downwardly from the arms 18. The arms 18 further include apertures 28 generally in a position where the arms 18 transition to the downwardly directed extensions 26. In an exemplary embodiment, the apertures 28 are located radially interior of a shoulder 27 which forms the transition between the arms 18 and the extensions 26. Thus when operably arranged, each projection 24 is aligned with an arm 18/extension 26 and is positioned radially interior of the extension 26. In assembly, each projection 24 extends through an associated aperture 28 to movably connect the upper assembly 12 to the lower assembly 14. This moveably connects the sear plate 20 to the arms 18. The projections 24 terminate in a tab 30, which may be a bent portion of the projection 24 to thereby retain the sear plate 20 to the arms 18. Thus when the sear tool 10 is in a fully extended position, the tabs 30 engage a top surface of the arms 18 to limit further expansive movement between the upper assembly 12 and the lower assembly 14. It is to be recognized that in other embodiments, while not depicted, that the upper assembly 12 may structurally connect fully or partially between the arms 18, thus fully or partially closing the upper assembly 12.

The tabs 30 thereby define a fully extended position for the sear plate 20 to extend away from the arms 18. The respective dimensions of the projections 24 and the apertures 28 define a fully compressed position of the sear plate 20 relative to the arms 18. The shape of the projections 24 increases a cross sectional width of the projections 24 through the apertures 28 as the sear plate 20 moves to the compressed position. At the fully compressed position, the width of the projections 24 equals the width of the apertures 28 and projections engage the sides of the apertures 28, limiting further movement of the sear plate 20 towards the arms 18. It will be understood that in embodiments of the sear tool 10, when in the lowermost or fully extended position, the sear plate 20 exemplarily extends downwardly even with or past the ends of the extensions 26, while in the uppermost or fully compressed position, the sear plate 20 is a predetermined distance above the ends of the extensions 26. Therefore, in use, the sear tool 10 may be designed such that a predetermined distance e.g. a predetermined patty thickness may be defined for the sear tool 10 such that a compression of the patty 22 is limited as described in further detail herein.

A spring 32 which may exemplarily be a leaf spring or flat spring, although other forms of springs including those explained in further detail herein may be used within the embodiment. The spring 32 applies a biasing force between upper assembly 12 and the lower assembly 14 that separates these structures and biases the sear plate 20 to the fully extended position exemplarily defined above by engagement of the tabs 30 and the arms 18.

In use, a user grips the handle 16 and engages the burger patty 22 with the sear plate 20. As the user applies a downward force against the handle 16, the downward force is first dampened by the spring 32 and translated through the sear tool 10 to the burger patty 22 against the cooking surface (not depicted). If sufficient force is applied to the handle 16, the extensions 26 will engage the cooking surface at which point the sear plate 20 is disengaged from the application of further additional force from the user through the handle 16, arms 18, and extensions 26 as that force is transferred through to the cooking surface. Rather, once the extensions 26 engage the cooking surface, any additional force on the burger patty 22 is applied solely through the force of the spring 32 against the sear plate 20. In this manner, a repeatable and consistent searing force is applied to each burger patty, particularly when the burger patties 22 are of a uniform size and thickness.

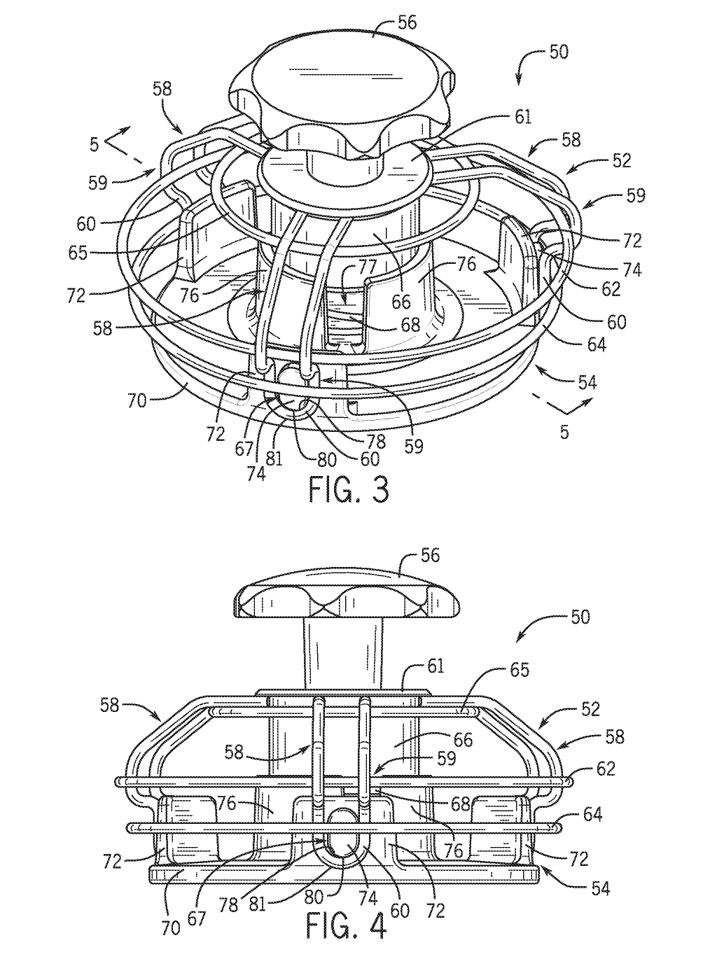

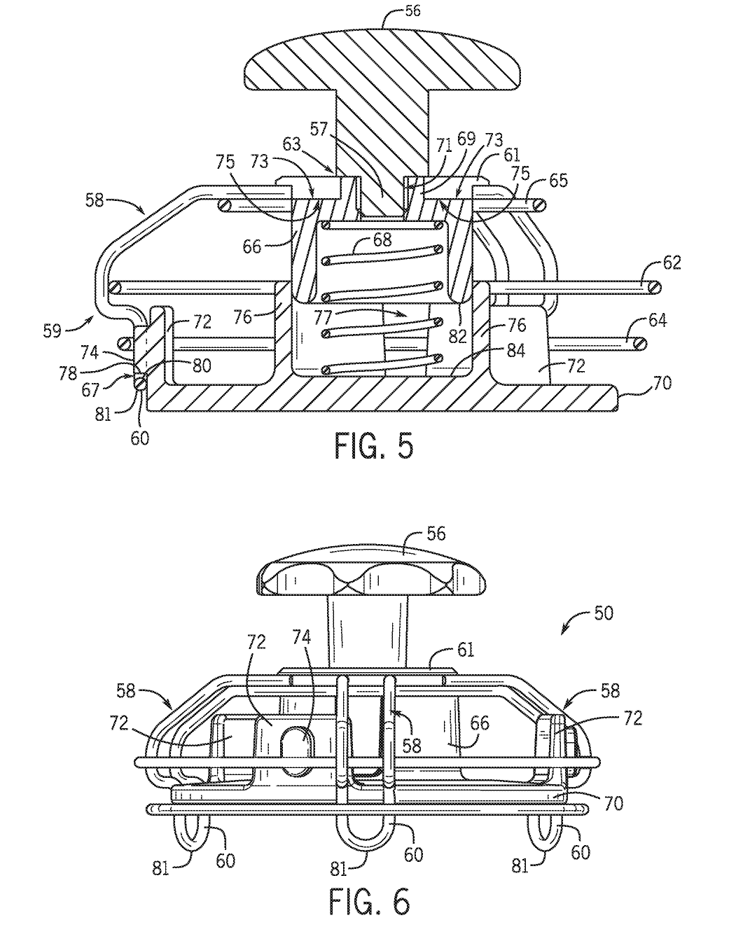

FIGS. 3-5 depict an additional exemplary embodiment of a sear tool 50. FIG. 3 is a perspective view of the sear tool 50. FIG. 4 is a front view of the sear tool 50. FIG. 5 is a section view of the sear tool 50 taken along line 5-5 of FIG. 3. While some features of the sear tool 50 are different than the embodiment of the sear tool 10 depicted in FIGS. 1 and 2, a number of features operate in a similar manner and achieve operational results similar to those as described above with respect to the sear tool 10. The sear tool 50 includes an upper assembly 52 and a lower assembly 54.

The upper assembly 52 includes a handle 56. The upper assembly is exemplarily constructed of a wire frame which includes one or more bent and/or welded wires to create a plurality of arms 58 which terminate in downwardly directed extensions 59, exemplarily formed as extension loops 60. A top plate 61 is annular in shape and centrally connects each of the arms 58. The handle 56 is further secured to the top plate 61 exemplarily by a projection 57 of the handle 56 that extends through an aperture 63 of the top plate 61 as depicted in FIG. 5. A top ring 65 is located radially outward from the top plate 61 and connects and supports the arms 58.

The upper assembly 52 further includes an upper body ring 62 and a lower body ring 64. The upper body ring 62 and lower body ring 64, in addition to the top ring 65 provide structural support to and between each of the arms 58 and give the device strength against damage or bending or breaking of the arms. The upper body ring 62 and lower body ring 64 further define the extension loops 60 of the downwardly directed extensions 59 in the manner as described in further detail herein. The extension loops 60 define apertures 67 within which knobs 74 (of the sear plate 70 as described further below) are movably received. Particularly the lower body ring 64 which is secured radially outwards across the extension loops 60 defines a radially outward extent of the apertures 67. In an embodiment, the knobs 74 slidingly engage the inner surface of the lower body ring 64.

While the embodiment of the upper assembly 52 of the sear tool 50 has been described herein as constructed of a wire frame, a person of ordinary skill in the art will recognize that in alternative embodiments, the upper assembly 52 may be constructed more similarly to the embodiment of the sear tool 10 as depicted in FIGS. 1-2. For example, the arms 58 may be constructed of solid pieces of material. In such embodiments, the top plate 61 may be integral to the arms 58 and some embodiments may not need the support rings. In an embodiment, the apertures 67 may either be formed through the extensions 59 or may be blind channels formed into the extensions 59.

The upper assembly 52 further includes a spring cylinder 66 which at least partially houses a spring 68. The spring 68 may be a coil spring or another form of spring as recognized by a person of ordinary skill in the art. In an exemplary embodiment, the spring cylinder 66 may include a cylinder projection 69 with a hole 71 formed therethrough. The cylinder projection may exemplarily be received through the aperture 63 while a shoulder 73 of the spring cylinder 66 engages a lower surface 75 of the top plate 61. The handle 56 exemplarily engages the cylinder projection 69, for example by the handle projection 57 extending into the hole 71.

The lower assembly 54 includes a sear plate 70 from which a plurality of projections 72 extend. The projections 72 include knobs 74 that extend radially outwards from the projections 72. Each projection 72 with a knob 74 of the lower assembly 54 corresponds to an extension 59 with an aperture 67 of the upper assembly 52. The knobs 74 are configured to be received within and travel within the apertures 67 defined by extension loops 60 as the sear plate 70 moves between the fully extended position and the fully compressed position.

The lower assembly 54 further includes at least one cylinder guide 76. As depicted in FIGS. 3-5 one exemplary embodiment includes three cylinder guides 76 which are defined about a circumference of a circle. In an embodiment, the at least one cylinder guide 76 may itself be cylindrical, although it has been recognized that in embodiments wherein gaps 77 are located between at least two cylinder guides 76, cleaning of the device is facilitated by increased access into the interior of the cylinder guides 76 and the spring cylinder 66. The at least one cylinder guide is located at a position radially outwards from the spring cylinder 66 such that when the upper assembly 52 and the lower assembly 54 are connected, the spring cylinder 66 is located radially interior of the at least one cylinder guide 76. In an exemplary embodiment, the outer radius of the spring cylinder 66 and the at least one cylinder guide 76 are closely dimensioned so that in use, the at least one cylinder guide 76 moveably engages the spring cylinder 66 and defines a location of the spring cylinder 66 and the spring 68 relative to the sear plate 70.

As previously described, the sear plate 70 moves between a fully extended position and a fully compressed position. The fully extended position is exemplarily defined by engagement of a lower portion 78 of the knobs 74 with a lower portion 80 of the apertures 67 as defined by the bottom portions of the extension loops 60 while the upper most position of the sear plate 70 may be exemplarily defined either by a maximum compression of the spring 68 or a physical engagement between a lowermost portion 82 of the spring cylinder 66 with the top side 84 of the sear plate 70 at a location near the cylinder guide 76. Maximal compression of the spring 68 or engagement of the spring cylinder 66 and the sear plate 70 prevent any further movement of the lower assembly 54 and/or the upper assembly 52 towards one another.

In an embodiment, the sear tool 50 operates in a similar manner as described above with respect to the sear tool 10. The user positions the sear tool 50 over the food on a cook surface, exemplarily a grill or griddle surface. The user engages the food with the lower side of the sear plate 70 and applies a compressive force against the handle 56. The spring 68 dampens the compressive force applied to a food product engaged by the sear plate 70 when the force is applied to the handle 56 in a downward manner. While this compressive force compresses the food product, the compressive force also overcomes any biasing force of the spring 68 keeping the upper assembly 52 and the lower assembly 54 apart. By overcoming the biasing force of the spring 68, the lower assembly 52 moves downwards towards the lower assembly 54. Further compression of the spring 68 will cause the extensions 59, particularly the lowermost portions 81 of the extension loops 60 to extend below the sear plate 70. Once the lowermost portions 81 of the extension loops 60 engage the cooking surface (not depicted), any additional force applied to the handle 56 beyond that needed to oppose the biasing force of the spring 66 is transferred through the extensions 59 to the cook surface, rather than applying any additional applied force to the food to be cooked. Therefore, the compressive force applied to the food by the sear plate is limited to the force produced by the spring 68 and sear plate rather than the force applied to the handle. In an exemplary embodiment, due to dimensions of, but not limited to the extension loops 60, the spring 68, spring cylinder 66, and/or cylinder guide 76, and/or interchangeability of the spring 68, various food thicknesses may be defined before the extension loops 60 engage the cooking surface.

An advantage of some embodiments of the sear tool 50 as described herein may be that the lower assembly 54 is removable from engagement with the upper assembly 52. In an embodiment, there may be sufficient travel between the lower assembly 54 and the upper assembly 52 that the knobs 74 can be moved up and out of the apertures 67 of the extensions 59. Once in this position, the lower assembly may 54 may be rotated relative to the upper assembly 52 to a position as depicted in FIG. 6. From this position the upper assembly 52 and the lower assembly 54 can be separated as the knobs 74 are slid interior of the lower body ring 64 and adjacent the extension loops. In this manner, the sear tool 50 can be disassembled for convenient cleaning. In another embodiment, the sear tool 50 can be disassembled to replace the lower assembly 54 and/or the spring 66 for example to reconfigure the sear tool 50 to change the force applied to the food by the spring 66/sear plate 70 or to change the maximum thickness of the food before the extensions engage the cook surface. In merely exemplary and non-limiting embodiments, this dimension may be ¼ inch ½ inch, 1 inch or 2 inches or another dimension as will be recognized based upon this disclosure.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A sear tool comprising:
an upper assembly comprising a handle and at least one extension terminating in an end;
a lower assembly comprising a sear plate and at least one projection and the lower assembly movably engages the upper assembly such that the sear plate is movable to a first position closer to the handle than the end of the at least one extension and the sear plate is movable to a second position even with or beyond the end of the at least one extension from the handle; and
a spring disposed between the upper assembly and the lower assembly, the spring biases the sear plate in the second position.

2. The sear tool of claim 1, wherein the upper assembly comprises a plurality of extensions each terminating in an end, and a plurality of arms, an arm of the plurality connected to an extension of the plurality of extensions, each of the plurality of arms connected to the handle.

3. The sear tool of claim 2, wherein when the sear plate is in the second position, the sear plate is distal the handle from the ends of the plurality of extensions.

4. The sear tool of claim 3, wherein second position is defined by engagement of the plurality of projections with the plurality of arms to prevent further movement in the direction of the second position.

5. The sear tool of claim 4, wherein each projection of the plurality of projections of the lower assembly further comprises a knob extending from the projection and each arm of the plurality of arms comprises an aperture and the knob of each projection is movably received within the aperture of each arm.

6. The sear tool of claim 5, wherein the apertures in the arms are open in a direction towards the handle such that when the sear plate is in the first position, the knobs are moved out of the apertures.

7. The sear tool of claim 6, wherein the arms are constructed of metal wire and the apertures are formed by extension loops of metal wire.

8. The sear tool of claim 4, further comprising;
a spring cylinder extending from the handle, the spring at least partially disposed within the spring cylinder;
at least one cylinder guide extending from the sear plate, the spring cylinder movably engages the at least one cylinder guide to align the upper assembly with the lower assembly.

9. The sear tool of claim 8, further comprising a top plate secured to the arms and further secured to the handle and the spring cylinder.

10. The sear tool of claim 4, wherein the spring is a leaf spring positioned between the sear plate and the plurality of arms.

11. The sear tool of claim 4, wherein each of the projections comprise inwardly slanting sides and the projections extend through apertures in each of the plurality of arms, wherein engagement of the inwardly slanting sides of the projections with the arms about the apertures define the first position of the sear plate.

12. The sear tool of claim 11, wherein each projection of the plurality of projections terminates in a tab and engagement of the tabs with the arms about the apertures define the second position of the sear plate.

13. A sear tool comprising:
an upper assembly comprising a handle and a plurality of arms, each arm of the plurality of arms comprising an extension that extends away from each arm and terminates in an extension end and each arm of the plurality of arms comprises an aperture;
a lower assembly comprising a sear plate and a plurality of projections that extend away from the sear plate, a portion of each projection of the plurality of projections extends into an aperture of an arm of the plurality of arms and the lower assembly is movably engaged with the upper assembly such that the upper assembly and the lower assembly are movable between a compressed position and an extended position; and
a spring disposed between the upper assembly and the lower assembly, the spring biases upper assembly and the lower assembly into the extended position.

14. The sear tool of claim 13, wherein the extended position is defined by engagement of the plurality of projections with the plurality of arms.

15. The sear tool of claim 13, further comprising;
a spring cylinder extending from the handle, wherein the spring is a coil spring and is at least partially disposed within the spring cylinder;
at least one cylinder guide extending from the sear plate, the spring cylinder movably engages the at least one cylinder guide to align the upper assembly with the lower assembly.

16. A method of cooking food comprising:
placing a piece of food on a cook surface;
engaging the piece of food with a sear tool comprising:
an upper assembly comprising a handle and a plurality of arms, each arm of the plurality of arms comprising an extension that extends away from each arm and terminates in an extension end;
a lower assembly comprising a sear plate and a plurality of projections that extend away from the sear plate, and the lower assembly is movably engaged with the upper assembly such that the upper assembly and the lower assembly are movable between a compressed position and an extended position; and
a spring disposed between the upper assembly and the lower assembly, the spring biases the sear plate in the extended position;
applying a force against the handle that overcomes the biasing force of the spring to move the lower assembly towards the cook surface;
engaging the cook surface with the extension ends; and
applying the biasing force of the spring against the food to aid searing.

17. The method of claim 16, further comprising dampening a force applied to the food from the force applied to the handle with the spring prior to engagement of the cook surface with the extension ends.

18. The method of claim 16 wherein a portion of each projection of the plurality of projections is respectively movably received within an aperture of each arm of the plurality of arms and further comprising:
moving the upper assembly and the lower assembly into the compressed position;
moving the portions of the projections out of the apertures of the arms;
rotating the upper assembly relative to the lower assembly; and
removing the lower assembly from engagement with the upper assembly.

19. The method of claim 18, wherein the spring is a first spring having a first biasing force and further comprising:
exchanging the first spring for a second spring having a second biasing force.

20. The method of claim 18, wherein lower assembly is a first lower assembly configured to achieve a first extended position and further comprising:
exchanging the first lower assembly for a second lower assembly configured to achieve a second extended position.
